(19) United States
(12) Patent Application Publication
(10) Pub. No.: US 2015/0358727 A1
(43) Pub. Date: Dec. 10, 2015

(54) ACTIVE BUFFETING CONTROL IN AN AUTOMOBILE

(71) Applicants: Gregory D. Rizzo, Bruce Township, MI (US); Todd Deaville, Markham (CA); Thomas Pilette, Lake Orion, MI (US); Anthony J. Povinelli, Romeo, MI (US); Urban Emborg, Ljungsbro (SE); Fredrik Samuelsson, Borensberg (SE); Gustav Kristiansson, Vreta Kloster (SE)

(72) Inventors: Gregory D. Rizzo, Bruce Township, MI (US); Todd Deaville, Markham (CA); Thomas Pilette, Lake Orion, MI (US); Anthony J. Povinelli, Romeo, MI (US); Urban Emborg, Ljungsbro (SE); Fredrik Samuelsson, Borensberg (SE); Gustav Kristiansson, Vreta Kloster (SE)

(73) Assignee: MAGNA INTERNATIONAL INC., Aurora, ON (CA)

(21) Appl. No.: 14/009,255

(22) PCT Filed: Mar. 30, 2012
(86) PCT No.: PCT/US2012/031497

§ 371 Date: Aug. 18, 2015

Related U.S. Application Data
(60) Provisional application No. 61/516,329, filed on Apr. 1, 2011.

(51) Int. Cl. H04R 3/00

(52) U.S. Cl. CPC H04R 3/002; H04R 2499/13

(57) ABSTRACT

An active buffeting noise control arrangement for a vehicle having one or more window panels of a vehicle cabin. One or more actuators are positioned at or near the one or more window panels and are operable to selectively vibrate the one or more windows in order to generate sound waves that will counteract a low frequency throb or buffeting event. The arrangement further includes one or more sensors in a vehicle cabin for detecting the buffeting event in transmitting sensor data to a control module. The control module is connected to the one or more sensors as well as the one or more actuators where the control module receives the sensory data, determines if a buffeting event is occurring and commands the one or more actuator assemblies to vibrate the window and generate sound waves that are operable to counteract the buffeting event.

### CROSS-REFERENCE TO RELATED APPLICATIONS

This application is a PCT International Application claiming priority to U.S. Patent Application No. 61/516,329 filed on 1 Apr. 2011.

### FIELD OF THE INVENTION

The present invention relates to an active buffeting noise control arrangement for a vehicle.

### BACKGROUND OF THE INVENTION

Automobiles exhibit a noticeable low frequency throb; referred to as buffeting, in the cabin when one or more windows are opened and the vehicle is moving at certain speeds. Buffeting is created by a change in cabin pressure, which causes sound pressures at frequencies below thirty hertz. Attempts have been made to eliminate or counteract the buffeting event using active airflow management on the exterior of the vehicle with varying degrees of success. Traditional active noise control arrangements have been attempted to counteract sound, however, they have not been able to effectively counteract sound pressures below the thirty hertz frequency range. There is a need to develop systems that will counteract buffeting. There is further a need to develop systems that are able to produce high pressure at very low frequencies in an efficient manner and there is a need for developing an arrangement for determining when a buffeting event is occurring and quickly counteract buffeting upon early detection.

### SUMMARY OF THE INVENTION

The present invention is directed to an active buffeting noise control arrangement for a vehicle having one or more window panels of a vehicle cabin. One or more actuators are positioned at or near the one or more window panels and are operable to selectively vibrate the one or more windows in order to generate sound waves that will counteract a low frequency throb or buffeting event. The arrangement further includes one or more sensors in a vehicle cabin for detecting the buffeting event and transmitting sensor data to a control module. The control module is connected to the one or more sensors as well as the one or more actuators where the control module receives the sensory data, determines if a buffeting event is occurring and commands the one or more actuator assemblies to vibrate the window and generate sound waves that are operable to counteract the buffeting event.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1a is a side plan view of a vehicle having an active buffeting noise control arrangement;

FIG. 1b is an overhead plan view of a vehicle having an active buffeting noise control arrangement;

FIG. 2a is a graph showing the effect achieved using the active noise control arrangement in an idling vehicle;

FIG. 2b is a graph showing the effect achieved using the active noise control arrangement in an idling vehicle;

FIG. 2c is a graph showing the effect achieved using the active noise control arrangement in an idling vehicle;

FIG. 2d is a graph showing the effect achieved using the active noise control arrangement in an idling vehicle; and

FIG. 3 is a graph showing the effect of using active noise control for reducing a buffeting even caused by the opening of a vehicle window.

### DETAILED DESCRIPTION OF THE PREFERRED EMBODIMENTS

The following description of the preferred embodiment(s) is merely exemplary in nature and is in no way intended to limit the invention, its application, or uses.

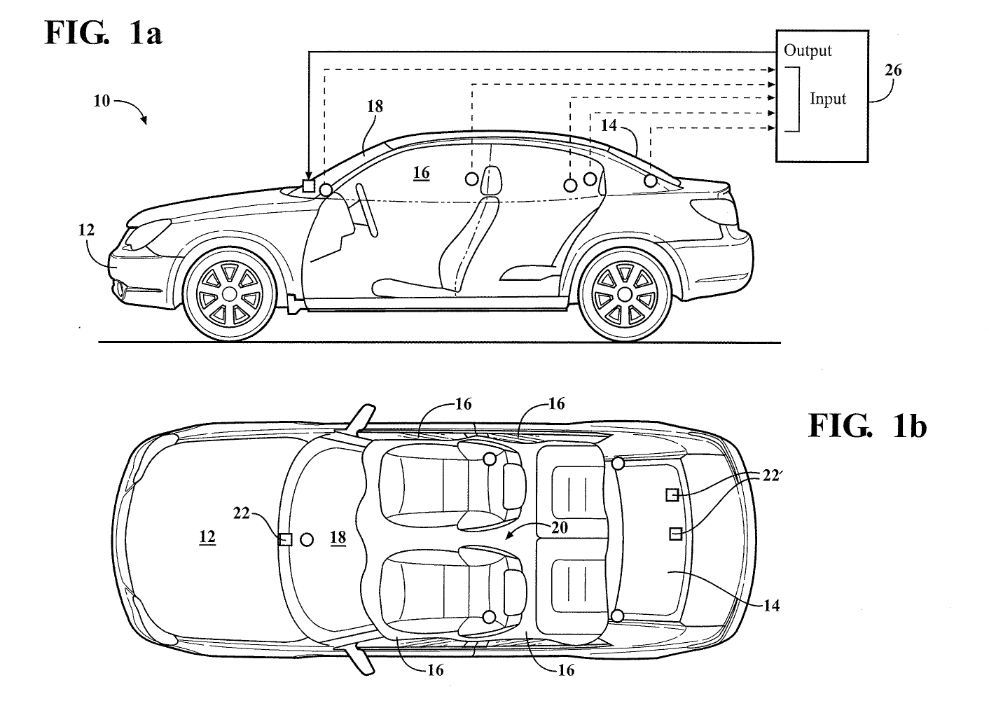

Referring now to FIG. 1a and FIG. 1b, an active buffeting noise control arrangement 10 for a vehicle 12 is shown. The vehicle 12 has one or more window panels which include, but are not limited to the rear window panel 14, one or more side window panels 16 and front window panel or front windshield 18 that form part of the boundaries of the vehicle cabin 20.

Connected to or near at least one of the window panels 14, 16, 18, are the one or more actuators 22, 22′. The one or more actuators 22, 22′ are operable to selectively vibrate the one or more window panels 14, 16, 18 using sound waves. In one preferred embodiment of the invention, the one or more actuators 22 are connected to the rear window panel 14 and can cause sound waves in a range of less than thirty hertz to be distributed throughout the vehicle cabin 20. In one embodiment, the present invention is used in connection with an invention described in US Patent Application Publication No. US2008/0232609A1, published Sep. 25, 2008, entitled “ACOUSTICAL WINDOW ASSEMBLY FOR VEHICLE”, which is hereby incorporated by reference into the present application. However, the scope of the present invention is not limited to actuators described in the above published application. It is within the scope of this invention for the actuators 22, 22′ to be any type of sound wave generator capable of generating sound waves below thirty Hertz. Suitable sound wave generators include but are not limited to automobile speakers, piezoelectric sound generators or piezoelectric speakers and air pressure generators. One or more sensors 24 are positioned within the vehicle cabin 20 and transmit sensor data including the detection of a buffeting event. The buffeting event can be caused by the opening of one or more of the side window panels 16 or other windows such as sun roofs, when the vehicle 12 is in motion. A buffeting event is defined as a low frequency sound wave or low frequency throb sound in the cabin. One type of buffeting event is caused by a change in cabin pressure caused by the opening of a window which causes a noticeable low frequency throb in the cabin. Other types of buffeting events include low frequency sound generated from engine idling or wind noise when the car is moving and the windows are closed as well as other buffeting events generated from sources in the outside environment. The low frequency throb is sound pressure in a frequency below about thirty hertz and preferably between about eight and about twenty Hertz.

The one or more sensors 24 are any type of sensor that is capable of detecting sound or pressure changes within the vehicle cabin 20. In one embodiment the one or more sensors 24 are pressure transducers or microphones capable of detecting sound waves within the vehicle cabin 20. In an alternate embodiment, the one or more sensors are a combination of different types of sensors positioned within the cabin. The placement of the one or more sensors 24 in the cabin varies depending upon the type of sensor being used. However, it is desirable to position the sensors 24 at a location that will allow for quick and early detection of the buffeting event in the vehicle cabin 20. In some applications, it is desirable to position the sensors at a location near the ears of a person seated in the vehicle cabin 20. For example, the sensors are positioned in the head rest of the vehicle seats.

The transmitted sensor data or input signals from the one or more sensors 24 is received by a control module 26 that determines if a buffeting event is occurring. The control module 26 is also connected to and sends command signals to the one or more actuators 22 that will in turn cause the one or more actuators 22 to vibrate the one or more window panels 14, 16, 18 that the one or more actuators 22 are operably connected with and generate cancelling sound waves that are operable to counteract or cancel the buffeting sound event within the vehicle cabin 20.

The control module 26 is programmed with one or more algorithms for determining the appropriate command signal and appropriate sound wave frequency to be generated by the one or more actuator assemblies based on input signals from the one or more sensors 24. In one embodiment of the invention, a suitable algorithm used for calculating a common signal or active noise control frequency is set forth below:

$$x ( n ) ≡ \hat{d} ( n ) = e ( n ) + {\sum }_{m = 0}^{M - 1} {\hat{s}}_{m} y ( n - m )$$

The above algorithm is used to estimate the primary noise detected by sensors 24 and use it as a reference signal x(n) for the active noise control (ANC) filter. The above algorithm is an adaptive feedback ANC system using filtered-x LMS (FXLMS) algorithm where the reference signal x(n) is synthesized as an estimate of the primary noise d(n). In the above equation \textcircled{S}m, m=0, 1, . . . , M−1 m are coefficients of the Mth order FIR filter used to estimate the secondary path. The above algorithm is used by the control module 26 in order to calculate the appropriate frequency generated using the acutators 22, 22′.

For example it is within the scope of this invention for multiple channels to be used with the control module 26 as well as multiple actuators 22 which may generate various frequencies in order to provide better counteract of the buffeting event. Factors used in calculating the control algorithm include, but are not limited to, the distance from sensor to the buffeting event source, such as a window, and the number of actuators being used. Additionally, the number of channels or the number of counteracting noise sound waves being generated by the actuators 22, 22′ can also affect the calculations made using the control algorithm. Additionally, the distance or placement of the multiple actuators 22, 22′ relative to the one or more window panels 14, 16, 18 can also have an effect on the calculations made by the control algorithm.

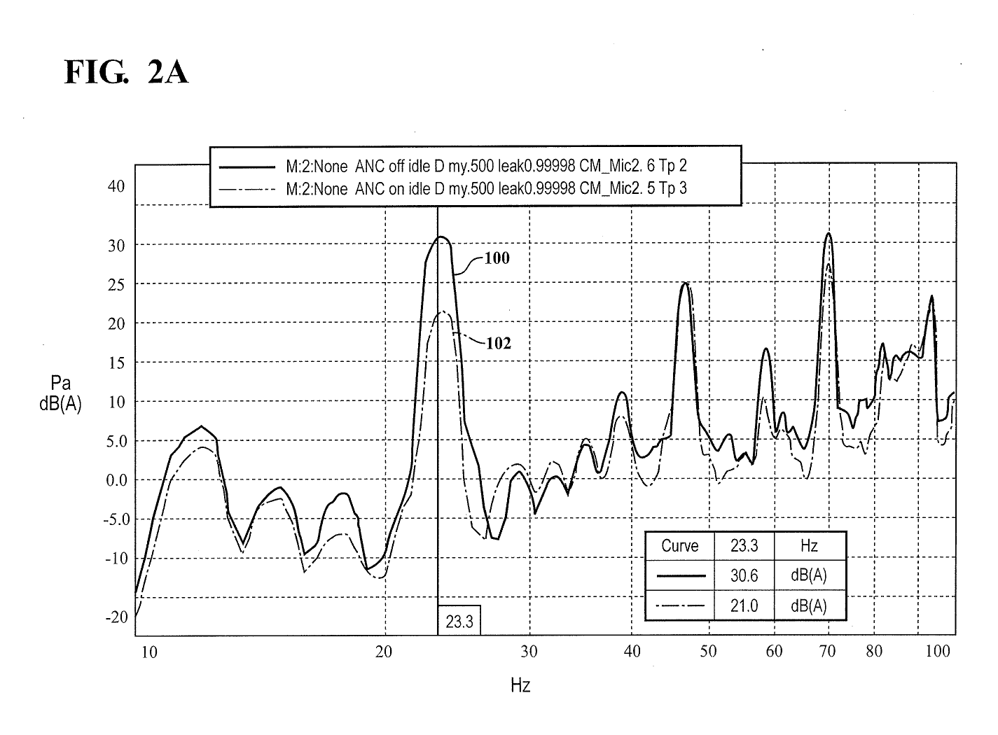

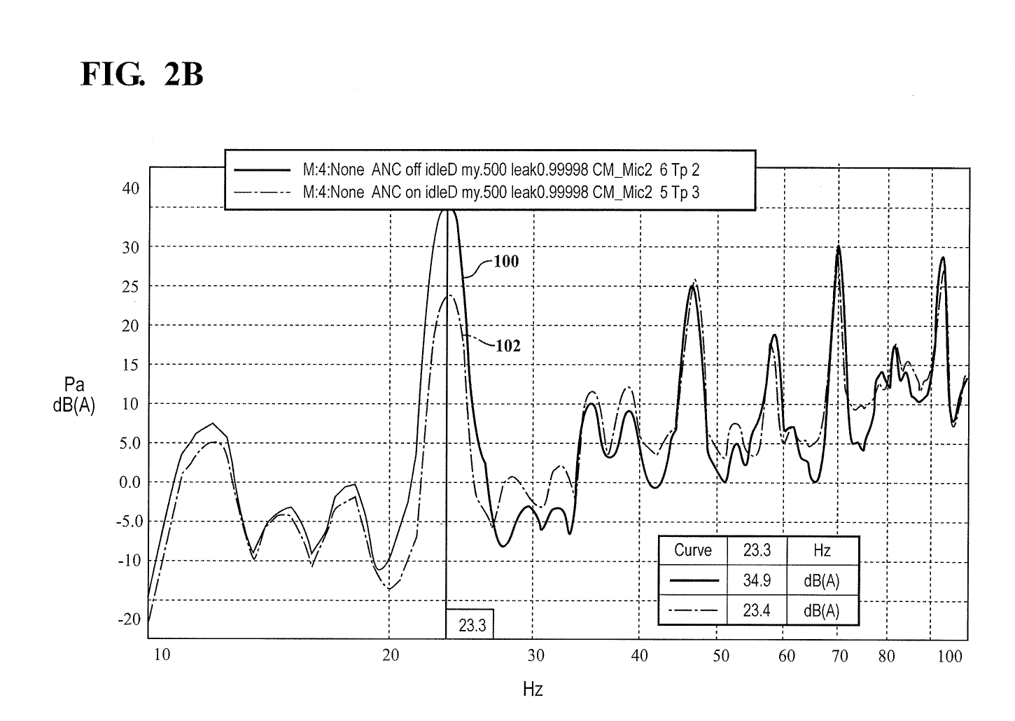

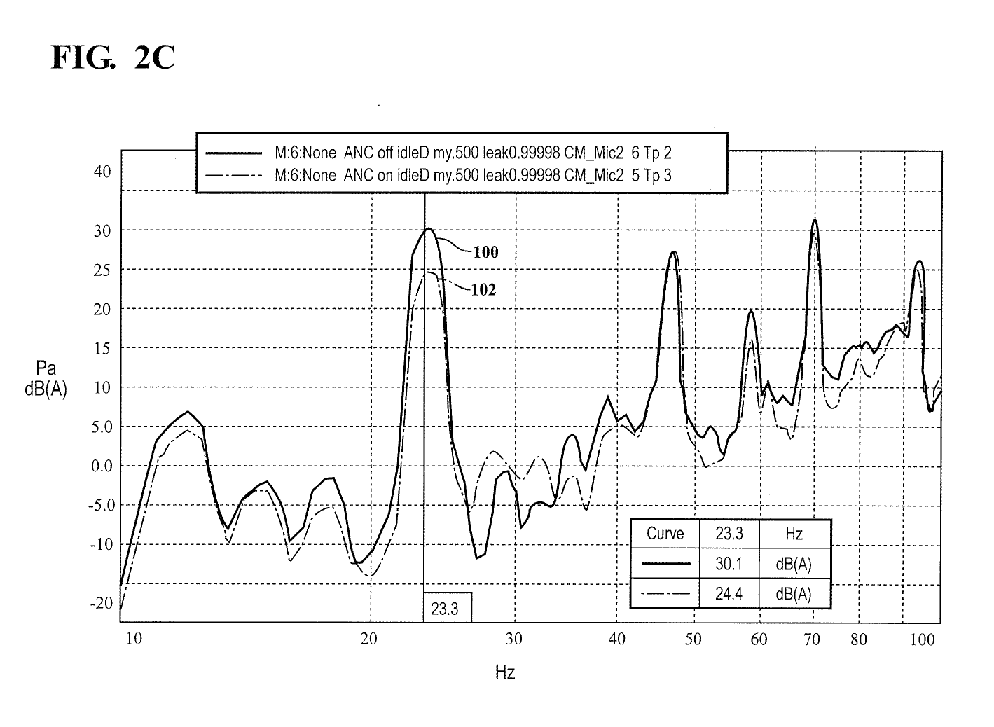

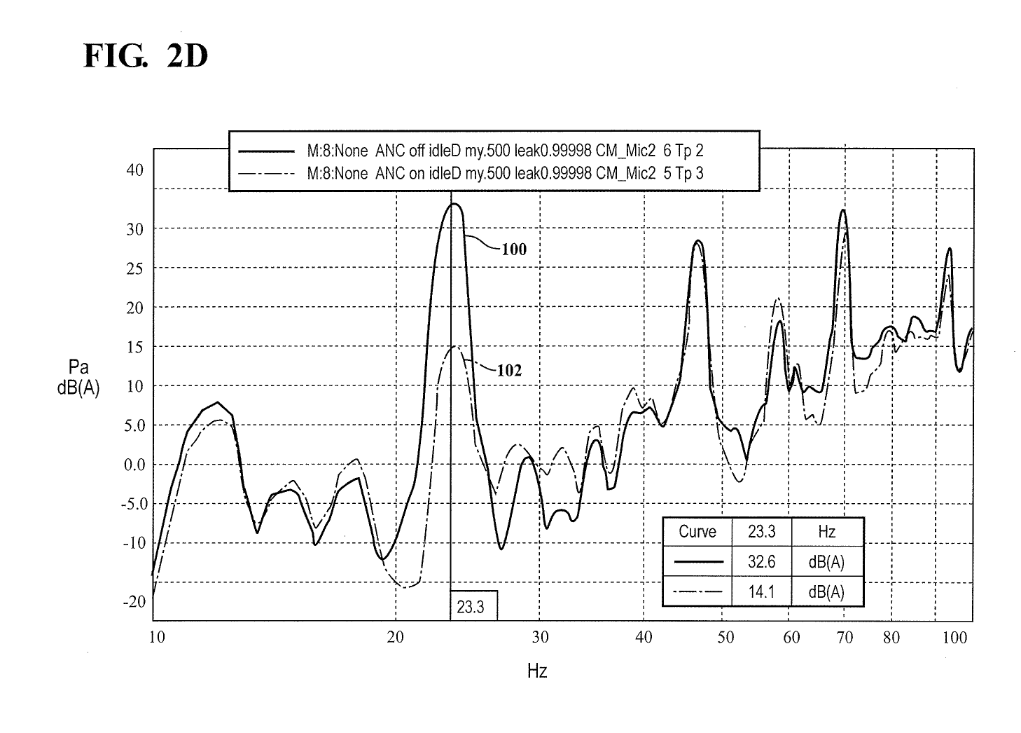

FIGS. 2a-2d are graphs showing the effect achieved using the active noise control arrangement in an idling vehicle in accordance with one embodiment of the present invention. Each graph, FIGS. 2a-2d, shows the decibels versus the hertz for one of four microphones placed at various locations within the vehicle cabin 20. The test measured sound levels in an idling vehicle with the windows closed. Referring now to all of the graphs, FIGS. 2a-2d, line 100 shows a graph of the decibel versus the hertz at a given microphone prior to activation of the active noise control arrangement in accordance with the present invention, while line 102 shows the decibels versus hertz values when the active noise control arrangement is generating cancelling sound waves in accordance with the present invention. The results demonstrate that using the cancelling sound waves generally lowers the decibels at all the recorded frequencies for each of the microphones. When the active noise control arrangement in accordance with the present invention is generating cancelling sound waves, the effect measured by each microphone shows that the decibels measured at each microphone are lowered in the range below thirty hertz. Traditional active noise control arrangements, including those using traditional subwoofers, are unable to generate cancelling sound waves below thirty hertz.

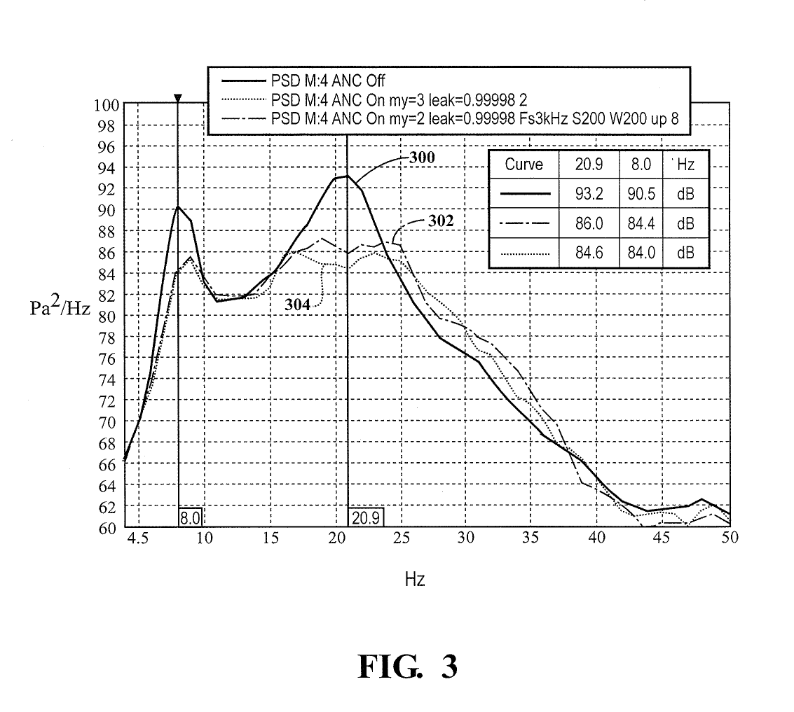

FIG. 3 is a graph that shows the effect achieved using the active noise control arrangement in accordance with the present invention for a buffeting event caused by an open window in the vehicle cabin. The graph shows the decibel versus hertz for one microphone placed within the vehicle cabin. Referring now to FIG. 3 line 300 shows the sound levels measured in the vehicle cabin prior to activation of the active noise control. Line 302 shows the measured sound levels in the vehicle cabin when the active noise control arrangement is activated. Line 304 shows the measured sound levels when the active noise control is on. The results demonstrated in the graph shown in FIG. 3 show that the use of the active noise control arrangement in accordance with the present invention significantly reduces the buffeting event in a range below thirty hertz and preferably between eight and twenty Hertz.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An active buffeting noise control arrangement for a vehicle comprising:
one or more window panels of a vehicle cabin;
one or more actuators positioned at or near said one or more window panels, said one or more actuators being operable to selectively vibrate said one or more window panels;
one or more sensors in the vehicle cabin for detecting a buffeting event and transmitting sensor data; and
a control module connected to said one or more sensors and said one or more actuators wherein said control module receives said sensor data, determines if a buffeting event is occurring and commands said one or more actuators to vibrate said one or more window panels and generate cancelling sound waves operable to counteract said buffeting event.

2. The active buffeting noise control arrangement of claim 1 wherein said window vibrates causing said cancelling sound waves to be in a range of less than thirty hertz, said cancelling sound waves being distributed throughout said vehicle cabin.

3. The active buffeting noise control arrangement of claim 1 wherein said window vibrates causing said cancelling sound waves to be in a between a range eight to twenty hertz, said cancelling sound waves being distributed throughout said vehicle cabin.

4. The active buffeting noise control arrangement of claim 1 wherein the control module further includes an algorithm represented by:
$$x ( n ) ≡ \hat{d} ( n ) = e ( n ) + {\sum }_{m = 0}^{M - 1} {\hat{s}}_{m} y ( n - m )$$
for calculating the cancelling sound waves that will be generated by the one or more actuator assemblies and the window.

5. The active buffeting noise control arrangement of claim 1 wherein said sensor data is used by said control module as a reference signal for calculating a command signal to be generated to said one or more actuators, wherein said command signal is used by said one or more actuators to vibrate said one or more window panels at a frequency determined by said command signal.

6. The active buffeting noise control arrangement of claim 1 wherein said one or more sensors are one selected from the group comprising pressure transducers or microphones capable of detecting sound waves within said vehicle cabin.

7. The active buffeting noise control arrangement of claim 1 wherein said one or more sensors are positioned within a headrest of a seat in said vehicle cabin.

8. The active buffeting noise control arrangement of claim 1 wherein said buffeting event is defined as a low frequency sound wave or throb sound in the cabin.

9. The active buffeting noise control arrangement of claim 8 wherein said low frequency sound wave or throb sound in the cabin is caused by the opening of one or more side window panels of said cabin or a sunroof.

10. The active buffeting noise control arrangement of claim 8 wherein said low frequency sound wave or throb sound in the cabin is generated from engine idling or wind noise when the vehicle is in motion and said one or more window panels of said vehicle cabin are closed.

11. The active buffeting noise control arrangement of claim 8 wherein the low frequency sound wave or throb sound in the cabin is sound pressure in a frequency below about 30 Hz.

12. The active buffeting noise control arrangement of claim 11 wherein the low frequency sound wave or throb sound in the cabin is in a range between about 8 Hz and about 20 Hz.

13. An active buffeting noise control arrangement for a vehicle comprising:
a windshield panel of a vehicle cabin;
one or more side windows of a vehicle cabin;
one or more actuators positioned at or near said windshield, said one or more actuators being operable to selectively vibrate said one or more window panels;
one or more sensors in the vehicle cabin for detecting a buffeting event and transmitting sensor data, wherein said buffeting event occurs when said one or more side window panels are opened; and
a control module connected to said one or more sensors and said one or more actuators wherein said control module receives said sensor data, determines if a buffeting even is occurring and commands said one or more actuators to vibrate said windshield and generate canceling sound waves operable to counteract said buffeting event.

9. The active buffeting noise control arrangement of claim 13 wherein said window vibrates causing said cancelling sound waves to be in a range of less than thirty hertz, said cancelling sound waves being distributed throughout said vehicle cabin.

10. The active buffeting noise control arrangement of claim 13 wherein said window vibrates causing said cancelling sound waves to be in a between a range eight to twenty hertz, said cancelling sound waves being distributed throughout said vehicle cabin.

11. The active buffeting noise control arrangement of claim 13 wherein the control module further includes an algorithm represented by:
$$x ( n ) ≡ \hat{d} ( n ) = e ( n ) + {\sum }_{m = 0}^{M - 1} {\hat{s}}_{m} y ( n - m )$$
for calculating the cancelling sound waves that will be generated by the one or more actuator assemblies and the window.

12. The active buffeting noise control arrangement of claim 13 wherein said sensor data is used by said control module as a reference signal for calculating a command signal to be generated to said one or more actuators, wherein said command signal is used by said one or more actuators to vibrate said one or more window panels at a frequency determined by said command signal.

13. The active buffeting noise control arrangement of claim 13 wherein said one or more sensors are one selected from the group comprising pressure transducers or microphones capable of detecting sound waves within said vehicle cabin.

14. The active buffeting noise control arrangement of claim 13 wherein said one or more sensors are positioned within a headrest of a seat in said vehicle cabin.
